(19) United States
(12) Patent Application Publication
(10) Pub. No.: US 2004/0013301 A1
(43) Pub. Date: Jan. 22, 2004

(54) Method for rectangle localization in a digital image

(76) Inventor: Eric Martin Dedrick, Lafayette, IN (US)

Correspondence Address: Eric Dedrick, 244 Ingram Dr., Lafayette, IN, 47909, US

(21) Appl. No.: 10/198,025

(22) Filed: Jul. 18, 2002

(51) Int. Cl. G06K 9/46; G06K 9/18

(52) U.S. Cl. 382/203; 382/183

(57) ABSTRACT

A method for the recognition of a rectangular shape of any size in any orientation based upon analysis of rotationally invariant and scale invariant quantities.

### REFERENCE TO A COMPUTER PROGRAM LISTING

This application contains a computer program listing on a compact disk appendix.

### BACKGROUND

1. Field of Invention

Given a digital image, this algorithm provides a means for the localization of any rectangular shape, such as barcode symbols, of any size, shape, or orientation.

2. Prior Art

Information is frequently encoded in a format designed for easy machine processing through the use of barcode symbols. Barcode symbols are comprised of a series of parallel rectangles of varying widths, heights, or placements. One type of barcode reader is one in which a digital image is acquired by a charge coupled device (CCD) and analyzed by a computer program or its equivalent digital electronics.

Extracting the barcode information from a digital image is typically done by isolating the barcode from the rest of the image (localization), classifying the different bars based on features such as height, width, or placement, and finally decoding the different symbols. Localization is often accomplished through a raster scan of the entire image and convolution with a template pattern, and the classification of the bars is often done by the comparison of multiple scan lines made through the region of interest.

There are several difficulties associated with these techniques. Often techniques that prove effective for the localization and classification of one type of barcode can not be successfully applied to a barcode of a different type. Generally, all techniques suffer difficulties when the quality of the barcode symbols has been degraded or when the barcode has an angular skew. There are many methods for dealing with these problems, but generally the solutions are not simple and requires significant computation. Clearly, a more effective technique would be desirable.

### OBJECTS AND ADVANTAGES

Accordingly, my algorithm has several objects and advantages. Since it is based upon a scale invariant, rotationally invariant quantity (henceforth called the geometric value) believed to have a value very specific to rectangles, this algorithm can be used to localize any type of barcode of any size in any orientation. Since the geometric value of a rectangle is very specific, it is possible to permit a large amount of tolerance in this value, allowing the algorithm to function well on barcode symbols of poor quality. Furthermore, all of the necessary calculations for determining the geometric value are computationally efficient for digital machines. Finally, this method can be used in combination with others to achieve very fast and accurate localization, classification, and decoding of barcode symbols.

### SUMMARY OF INVENTION

The present algorithm is able to recognize objects of a rectangular geometry by calculating a scale invariant, rotationally invariant quantity and comparing that value to a theoretical value believed to be specific to rectangles. Additionally, this method has been combined with others to yield a procedure tuned for the localization, classification, and decoding of postnet barcodes.

### THEORY OF OPERATION

The use of the geometric value to test for rectangular geometry is a novel approach based upon a physical model. The rotational properties of any physical object are given by its moment of inertia tensor I. Most generally,

$$I = ( \begin{matrix}\sum {m}_{i} ( {r}_{i}^{2} - {x}_{i}^{2} ) & - \sum {m}_{i} {x}_{i} y & - \sum {m}_{i} {x}_{i} {z}_{i} \\ - \sum {m}_{i} {y}_{i} {z}_{i} & \sum {m}_{i} ( {r}_{i}^{2} - {y}_{i}^{2} ) & - \sum {m}_{i} {y}_{i} {z}_{i} \\ - \sum {m}_{i} {z}_{i} {x}_{i} & - \sum {m}_{i} {z}_{i} {y}_{i} & \sum {m}_{i} ( {r}_{i}^{2} - {z}_{i}^{2} )\end{matrix} ) \qquad ( 1 )$$

where mᵢ is the mass of the ith small element of the object, xᵢ, yᵢ, and zᵢ are the distances from the object's center of mass to the x, y, and z coordinates of the ith small element respectively, the summation extends over all of the small elements, and

$${r}_{1} = \sqrt{{x}_{i}^{2} + {y}_{i}^{2} + {z}_{i}^{2}} .$$

This model can be adapted to the recognition of a rectangular shape in a digital image by assigning to each pixel a mass of unity (or a weighting coefficient), recognizing that all pixels are constrained to the z=0 plane, and performing the summation over all pixels in the object,

$$I = ( \begin{matrix}\sum {y}_{i}^{2} & {\sum }^{} {x}_{i} {y}_{i} & 0 \\ - \sum {y}_{i} {x}_{i} & \sum {x}_{i}^{2} & 0 \\ 0 & 0 & \sum ( {x}_{i}^{2} + {y}_{i}^{2} )\end{matrix} ) \qquad ( 2 )$$

Equation 2 can be used to efficiently calculate the moment of a cluster in a digital image.

For a rectangle of length L, width h, and area A, with mass density equal to unity, and with suitably chosen coordinates whose origin is at the object's center of mass,

$$I = ( \begin{matrix}\frac{1}{12} {AL}^{2} & 0 & 0 \\ 0 & \frac{1}{12} {Ah}^{2} & 0 \\ 0 & 0 & \frac{1}{12} A ( {L}^{2} + {h}^{2} )\end{matrix} ) \qquad ( 3 )$$

Two rotationally invariant quantities of this tensor are its trace and determinant,

$$\begin{matrix}tr ( I ) = \frac{1}{6} A ( {L}^{2} + {h}^{2} ) , \\ and & ( 4 ) \\ det ( I ) = \frac{1}{{12}^{3}} {A}^{3} {L}^{2} {h}^{2} ( {L}^{2} + {h}^{2} ) . & ( 5 )\end{matrix}$$

Taking the ratio of these two quantities,

$$\begin{matrix}\frac{tr ( I )}{det ( I )} = \frac{288}{{A}^{4}} , \\ or & ( 6 ) \\ {A}^{4} \frac{tr ( I )}{det ( I )} = 288. & ( 7 )\end{matrix}$$

The left hand side of equation 7 is named the geometric value of the object, a scale invariant, rotationally invariant quantity.

Thus, the geometric value of an object may be computed by use of equation 2 and compared to the theoretical value of 288. Hence, the geometric value serves as a means for identifying objects of a rectangular shape.

### DESCRIPTION OF INVENTION

In addition to inventing a novel theory for assessing the rectangular shape of a cluster described in the theory of operation section, a method was also designed for decoding a postnet barcode from an image. The procedure begins with the segmentation of a monochromatic digital image by component labeling using an 8-connected neighborhood. The removal of most, if not all, non-barcode clusters was achieved with three filtering methods.

For a device such as a high speed mail sorting system, it is reasonable to assume the size of the postnet barcode appearing on the face of each letter would approximately be the same from letter to letter. There would be a maximum value for the number of pixels which could comprise a cluster that is part of the barcode, and, similarly, there would be a minimum value. These values, once determined for a particular system, should be used to rapidly reduce the number of barcode-candidate clusters before applying the the other two filters.

Secondly, filtering based upon the novel geometric value discussed in the theory of operation section should be used to remove barcode candidate clusters whose value exceeds and maximum or is below a minimum threshold. Although a perfect rectangle has a geometric value of 288, experiments have shown that a 50% tolerance in this value is necessary to deal with barcodes of exceptionally poor quality. A large number of cluster shapes have been used to test the uniqueness of the value of 288 to a rectangle, including all alphabetic characters in a variety of fonts, of which almost all values of which were below 40, excluding the uppercase “I” and lowercase “l” when drawn as rectangles. This degree of uniqueness allows for large tolerances in the geometric value which are useful for correctly recognizing the symbols of poor quality barcodes.

After the application of the size and geometric value filters, almost all non-barcode clusters have been removed, except for the occasional stray line or rectangle shaped letter. Since these clusters are usually quite spatially isolated, they can be easily removed by requiring that all barcode candidate clusters be within some threshold distance of another cluster that has thus far successfully passed all filtering tests.

Now that all, or nearly all, of the non-barcode clusters have been removed, it is possible to begin decoding the barcode. For this particular application the decoding method began by selecting the left most cluster as the start bar, and then selected the next the next closest cluster to the right as the next bar. The process was repeated until the barcode was either successfully decoded or an error was encountered. In the event of an error, the barcode immediately to the right of the start bar was selected as the new start bar, and the procedure was repeated.

In the event that a barcode can not be decoded, it is possible to adjust one or more of the adjustable thresholds and make another decoding attempt. This was not necessary as the algorithm proved to be 96% accurate on a set of 100 test images, requiring on average only 0.069 seconds to process an image of approximately 200 kilobytes on a 500 MHz pentium computer.

One disadvantage of this method is that barcode symbols which are broken and no longer 8-connected require special techniques to reconnect the clusters before the algorithm can be applied.

### CONCLUSION, RAMIFICATIONS, AND SCOPE OF INVENTION

A novel method for the recognition of a rectangle by its unique geometric value, based on scale and rotationally invariant quantities, has been presented. It has been shown to be effective in combination with other methods in the decoding of postnet barcodes from digital images in which the barcode is of poor quality.

While the above description contains many specificities, these should not be construed as limitations on the scope of the invention, but rather as an exemplification of one preferred embodiment thereof. Many other variations are possible. For example, use of the geometric value would also be useful as a step in the decoding of any type of barcode, or, even more generally, the recognition of any type of rectangular shape. Accordingly, the scope of the invention should be determined not by the embodiment illustrated, but by the appended claims and their legal equivalents.

What is claimed is:

1. A method for recognizing objects of a rectangular shape in a digital image from a charge coupled device or similar device comprising the steps of:
a) calculating the area of the shape,
b) calculating the trace and determinant of the object's second order moment tensor,
c) and combining these values in a manner which permits comparison with a theoretical value.

2. A method based on claim one for decoding a barcode comprising these steps of:
a) component labeling,
b) rejection of clusters based upon area,
c) rejection of clusters based upon the method of claim 1,
d) and a decoding step.
